(19) United States
(12) Patent Application Publication
(10) Pub. No.: US 2026/0337356 A1
(43) Pub. Date: Oct. 29, 2026

(54) CHLORINATED VINYL CHLORIDE RESIN COMPOSITION FOR FOAMING AND FOAM MOLDED ARTICLE

(71) Applicant: KANEKA CORPORATION, Osaka (JP)

(72) Inventor: Takehiro Nakaseki, Hyogo (JP)

(73) Assignee: KANEKA CORPORATION, Osaka (JP)

(21) Appl. No.: 19/576,749

(22) Filed: Mar. 24, 2026

(30) Foreign Application Priority Data
Mar. 24, 2025 (JP) 2025-048979
Feb. 19, 2026 (JP) 2026-025776

(51) Int. Cl. C08J 9/00; C08K 5/06; C08K 5/11; C08K 7/00; C08L 27/06

(52) U.S. Cl. CPC C08J 9/0061; C08J 9/0023; C08J 9/0066; C08K 5/06; C08K 5/11; C08K 7/00; C08L 27/06; C08K 2201/005; C08L 2203/14; C08L 2205/06

(57) ABSTRACT

A foamable chlorinated polyvinyl chloride resin composition includes a chlorinated polyvinyl chloride resin composition in an amount of 100 parts by weight, a plasticizer in an amount of 30 to 60 parts by weight, a processing aid for foam molding in an amount of 3 to 30 parts by weight, and a molding shrinkage inhibitor in an amount of 10 to 40 parts by weight. The processing aid for foam molding is an acrylic polymer, and the molding shrinkage inhibitor is a flaky inorganic powder having a mean particle size (D50) of 4 to 10 μm.

### TECHNICAL FIELD

One or more embodiments of the present invention relate to a softened chlorinated polyvinyl chloride resin composition for foaming, and a foam molded article using the same.

### BACKGROUND

A chlorinated polyvinyl chloride resin composition is a resin prepared by chlorinating a polyvinyl chloride resin composition such that the resin has improved heat resistance and flame retardancy while maintaining its excellent weather resistance, mechanical properties, and the like. Like a polyvinyl chloride resin composition, such a chlorinated polyvinyl chloride resin composition is widely used as a material in various fields such as automobiles, machinery, electricity, medicine, and construction. For example, JP 2008-150588 A discloses a resin composition for use in construction and automobiles, the resin composition includes a chlorinated polyvinyl chloride resin composition, a phosphorus-based plasticizer, and an inorganic filler. JP 2022-55452 A discloses foamable polyvinyl chloride resin composition particles for use in construction, the foamable polyvinyl chloride resin composition includes a chlorinated polyvinyl chloride-based resin, a plasticizer, and a foaming agent.

JP 2008-150588 A and JP 2022-55452 A are examples of related art.

However, in the case where the resin composition described in JP 2008-150588 A is used for foaming, the expansion ratio is low. Also, the foamable polyvinyl chloride resin composition particles described in JP 2022-55452 A cannot be used as a softened resin composition. Furthermore, JP 2008-150588 A and JP 2022-55452 A fail to refer to molding shrinkage, specifically shrinkage during cooling after molding, and thus, there is a need to inhibit molding shrinkage.

### SUMMARY

One or more embodiments of the present invention provide a chlorinated polyvinyl chloride resin composition for foaming (hereinafter, it is also referred to as a foamable chlorinated polyvinyl chloride resin composition), which is softened, inhibits molding shrinkage, and can exhibit a high expansion ratio during foam molding. One or more embodiments of the present invention also provide a foam molded article using the foamable chlorinated polyvinyl chloride resin composition.

One or more of embodiments of the present invention relate to a foamable chlorinated polyvinyl chloride resin composition, which includes a chlorinated polyvinyl chloride resin composition in an amount of 100 parts by weight, a plasticizer in an amount of 30 to 60 parts by weight, a processing aid for foam molding in an amount of 3 to 30 parts by weight, and a molding shrinkage inhibitor in an amount of 10 to 40 parts by weight, where the processing aid for foam molding is an acrylic polymer, and the molding shrinkage inhibitor is a flaky inorganic powder having a mean particle size (D50) of 4 to 10 μm.

One or more of embodiments of the present invention relate to a foamable chlorinated polyvinyl chloride resin composition, which further includes a foaming agent.

One or more of embodiments of the present invention relate to a foam molded article obtained by foam molding the foamable chlorinated polyvinyl chloride resin composition according to one or more of embodiments.

One or more embodiments of the present invention provide a foamable chlorinated polyvinyl chloride resin composition, which is softened, inhibits molding shrinkage, and exhibits a high expansion ratio during foam molding, and one or more embodiments of the present invention provide a foam molded article which is softened, inhibits molding shrinkage, and has a high expansion ratio.

### DETAILED DESCRIPTION

The inventors of the present invention have conducted extensive studies, thereby finding the facts specified below. That is, a chlorinated polyvinyl chloride resin composition can be softened by blending a predetermined amount of plasticizer, and the expansion ratio during a foaming molding can be increased by blending a predetermined amount of acrylic polymer as a processing aid for foam molding. On the other hand, blending the plasticizer and the acrylic polymer in the chlorinated polyvinyl chloride resin composition may increase molding shrinkage. Surprisingly, however, a chlorinated polyvinyl chloride resin composition for foaming, which is softened, inhibits molding shrinkage, and exhibits a high expansion ratio during foam molding, can be obtained by using a chlorinated polyvinyl chloride resin composition in combination with a plasticizer, an acrylic polymer as a processing aid for foam molding, and a flaky inorganic powder having a mean particle size (D50) within a predetermined range.

In the present Specification, when a numerical range is indicated by “to”, the numerical range includes both end values (upper limit and lower limit). For example, a numerical range of “A to B” is a range including both end values of A and B, and is the same range as “A or more and B or less”. Further, any number within the range and any range within the range are specifically disclosed. Further, in the case where a plurality of numerical ranges are described in the present Specification, a numerical range obtained by appropriately combining upper limits and lower limits of different numerical ranges is included. Further, in the case where a plurality of upper limits and lower limits are separately described for a numerical range, a numerical range obtained by appropriately combining upper limits and lower limits is included.

### Chlorinated Polyvinyl Chloride Resin Composition

A chlorinated polyvinyl chloride resin composition (hereinafter, it is also referred to simply as a resin composition) according to one or more of embodiments of the present invention includes a chlorinated polyvinyl chloride resin composition, a plasticizer, a processing aid for foam molding, and a molding shrinkage inhibitor.

The chlorinated polyvinyl chloride resin composition is not particularly limited, and a polyvinyl chloride resin composition may be appropriately used after chlorination. The chlorination of the polyvinyl chloride resin composition may be carried out, for example, by a method of dispersing the polyvinyl chloride resin composition in water and irradiating with ultraviolet rays while blowing a chlorine gas, or by a method of dispersing the polyvinyl chloride resin composition in water and then heating and introducing an oxidizing agent while blowing a chlorine gas. Alternatively, the chlorination may be carried out by a method of flowing the polyvinyl chloride resin composition into a chlorine gas and irradiating with ultraviolet rays.

The chlorine content of the chlorinated polyvinyl chloride resin composition is not particularly limited, but may be, for example, 60 to 75% by weight, may be 62 to 72% by weight, or may be 63 to 69% by weight. The average degree of polymerization of the chlorinated polyvinyl chloride resin composition is not particularly limited, but may be, for example, 400 to 1500 or may be 500 to 1200. In the present Specification, the chlorine content and the average degree of polymerization of the chlorinated polyvinyl chloride resin composition can be measured, for example, as described in Examples.

The mean particle size of the chlorinated polyvinyl chloride resin composition is not particularly limited but may be, for example, 0.1 to 350 μm, 5 to 250 μm, 10 to 230 μm, or 50 to 200 μm. In the present Specification, the mean particle size of the chlorinated polyvinyl chloride resin composition can be measured, for example, as described in Examples.

The polyvinyl chloride resin composition is not particularly limited and the examples include: a vinyl chloride homopolymer or a vinyl chloride copolymer of a vinyl chloride monomer and another monomer copolymerizable therewith.

The other monomers are not particularly limited, and the examples may include: olefins such as ethylene, propylene, and butene; vinyl esters such as vinyl acetate, vinyl propionate, and vinyl stearate; vinyl ethers such as methyl vinyl ether, ethyl vinyl ether, octyl vinyl ether, and lauryl vinyl ether; vinylidenes such as vinylidene chloride; unsaturated carboxylic acids such as acrylic acid, methacrylic acid, fumaric acid, maleic acid, itaconic acid, maleic anhydride, itaconic anhydride, and their acid anhydrides; unsaturated carboxylic acid esters such as methyl acrylate, ethyl acrylate, monomethyl maleate, dimethyl maleate, and butylbenzyl maleate; aromatic vinyl compounds such as styrene, α-methylstyrene, and divinylbenzene; unsaturated nitriles such as acrylonitrile; and, crosslinkable monomers such as diallyl phthalate. The amounts of these other monomers may be less than 50% by weight in the monomer mixture with the vinyl chloride. The vinyl chloride copolymer may include a structural unit derived from vinyl chloride in an amount of more than 50% by weight; it may include a structural unit derived from vinyl chloride in an amount of 55 to 95% by weight and one or more of structural units derived from other monomers in an amount of 5 to 45% by weight; a structural unit derived from vinyl chloride in an amount of 60 to 90% by weight and one or more of structural units derived from other monomers in an amount of 10 to 40% by weight; it may include a structural unit derived from vinyl chloride in an amount of 65 to 85% by weight and one or more of structural units derived from other monomers in an amount of 15 to 35% by weight; or it may include a structural unit derived from vinyl chloride in an amount of 70 to 85% by weight and one or more of structural units derived from other monomers in an amount of 15 to 30% by weight.

The polyvinyl chloride resin composition may be produced by any known polymerization method such as suspension polymerization, fine suspension polymerization, emulsion polymerization, and bulk polymerization.

The plasticizer is not particularly limited, and plasticizers for polyvinyl chloride resin compositions may be used as appropriate. Specific examples thereof include: phthalate-based plasticizers such as di-2-ethylhexyl phthalate (DOP), dinormal octyl phthalate, dibutyl phthalate, diisononyl phthalate (DINP), and butyl benzyl phthalate; phosphate ester-based plasticizers such as tricresyl phosphate, and tri-2-ethylhexyl phosphate; adipate-based plasticizers such as di-2-ethylhexyl adipate (DOA), diisodecyl adipate (DIDA), and diisononyl adipate (DINA); sebacate-based plasticizers such as di-2-ethylhexyl sebacate; azelate-based plasticizers such as di-2-ethylhexyl azelate; trimellitate-based plasticizers such as tri-2-ethylhexyl trimellitate; polyester-based plasticizers; benzoate-based plasticizers such as di-2-ethylhexyl benzoate, diethylene glycol dibenzoate, and 2,2,4-trimethyl-1,3-pentanediol isobutyrate benzoate; citrate-based plasticizers such as acetyl tributylcitrate; glycolate-based plasticizers; chlorinated paraffin-based plasticizers; chlorinated fatty acid ester-based plasticizers; epoxy-based plasticizers; fatty acid ester-based ether plasticizers; and formal-based ether plasticizers. Among them, at least one plasticizer selected from the group consisting of adipate-based plasticizers, fatty acid ester-based ether plasticizers and formal-based ether plasticizers may be used from the viewpoint of softening the chlorinated polyvinyl chloride resin composition and improving the powder flowability, and at least one ether plasticizer Z selected from the group consisting of fatty acid ester-based ether plasticizers and formal-based ether plasticizers may be used. One of these plasticizers may be used alone, or two or more of them may be used in combination.

The fatty acid ester-based ether plasticizer may further include a compound represented by general formula (1) below from the viewpoint of softening and powder flowability.

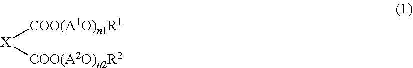

In the general formula (1), X is a linear or branched alkylene group having 1 to 9 carbon atoms, A¹ and A² are the same or different and each represent an alkylene group having 2 to 4 carbon atoms, R¹ and R² are the same or different and each represent a linear or branched alkyl group having 1 to 9 carbon atoms, n1 and n2 are the same or different and each represent an integer of 1 to 7, and n1+n2 is an integer of 3 or more.

More specific examples of the fatty acid ester-based ether plasticizer represented by the general formula (1) include an adipate-based ether plasticizer in which X in the general formula (1) represents an alkylene group having 4 carbon atoms or an azelate-based ether plasticizer in which X in the general formula (1) represents an alkylene group having 7 carbon atoms, and an adipate-based ether plasticizer may be used from the viewpoint of availability and versatility.

The adipate-based ether plasticizer may be, for example, an esterified compound of an adipic acid with two molecules of an ether alcohol. The ether alcohol may be one kind of ether alcohol or two kinds of ether alcohols. Examples of the ether alcohol used as a raw material for the adipate-based ether plasticizer include: ethylene oxide adducts or propylene oxide adducts of linear or branched aliphatic alcohols having 1 to 9 carbon atoms. More specifically, the examples include: ethylene oxide adducts such as ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, triethylene glycol monomethyl ether, triethylene glycol monoethyl ether, and triethylene glycol monobutyl ether; propylene oxide adducts such as propylene glycol monomethyl ether, propylene glycol monoethyl ether, propylene glycol monobutyl ether, dipropylene glycol monomethyl ether, dipropylene glycol monoethyl ether, dipropylene glycol monobutyl ether, tripropylene glycol monomethyl ether, tripropylene glycol monoethyl ether, and tripropylene glycol monobutyl ether.

Among them, diethylene glycol monomethyl ether, diethylene glycol monoethyl ether, diethylene glycol monobutyl ether, triethylene glycol monomethyl ether, triethylene glycol monoethyl ether, triethylene glycol monobutyl ether or the like may be used, and diethylene glycol monomethyl ether, diethylene glycol monoethyl ether, diethylene glycol monobutyl ether or the like may be used.

More specifically, the adipate-based ether plasticizers to be used include, for example, bis[2-(2-butoxyethoxy) ethyl] (also referred to as bisbutylcarbitol adipate), which is an ester compound of an adipic acid with two molecules of diethylene glycol monobutyl ether. Bisbutylcarbitol adipate is a compound represented by the general formula (1), wherein X represents an alkylene group having 4 carbon atoms, A¹ and A² each represent an ethylene group, n1 and n2 each are 2, and R¹ and R² each represent an n-butyl group.

The formal-based ether plasticizer may further include a compound represented by general formula (2) below from the viewpoint of softening and powder flowability.

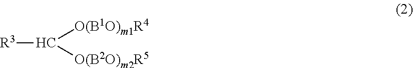

In the general formula (2), R³ represents hydrogen or an alkyl group having 1 to 3 carbon atoms, B¹ and B² are the same or different and each represent an alkylene group having 2 to 4 carbon atoms, R⁴ and R⁵ are the same or different and each represent a linear or branched alkyl group having 1 to 9 carbon atoms, and m1 and m2 are the same or different and each are an integer of 1 to 7.

As the formal-based ether plasticizer represented by the general formula (2), for example, a compound obtained by reacting two molecules of ether alcohol with an aldehyde compound such as formaldehyde and acetaldehyde can be used. The ether alcohol may be one kind of ether alcohol or two kinds of ether alcohols. For the ether alcohol used as the raw material of the formal-based ether plasticizer, an ether alcohol exemplified also as the raw material of the adipate-based ether plasticizer can be used.

More specifically, as the formal-based ether plasticizer represented by the general formula (2), for example, bis(butyl diethyl glycol)formal [also referred to as butyl carbitol formal] obtained by reacting formaldehyde with two molecules of diethylene glycol monobutyl ether can be used. The butyl carbitol formal is a compound represented by the general formula (2), wherein R³ represents hydrogen, B¹ and B² each represent an ethylene group, m1 and m2 each represent 2, and R⁴ and R⁵ each represent an n-butyl group.

From the viewpoint of availability, softening and powder flowability, the ether plasticizer Z may include at least one selected from the group consisting of bisbutyl carbitol adipate and butyl carbitol formal, and may include bisbutyl carbitol adipate.

The molecular weight of the ether plasticizer Z is not particularly limited, but may be, for example, 200 to 1500, or 250 to 1000 from the viewpoint of some effects such as softening effect, powder flowability, and inhibition of bleed-out on the surface of the molded article.

The resin composition includes the plasticizer in an amount of 30 to 60 parts by weight relative to 100 parts by weight of the chlorinated polyvinyl chloride resin composition. Thus, the resin composition can be softened and molding shrinkage can be easily inhibited. From the viewpoint of further enhancing softening, the resin composition may include the plasticizer in an amount of 33 parts by weight or more, 35 parts by weight or more, or 40 parts by weight or more, relative to 100 parts by weight of the chlorinated polyvinyl chloride resin composition. From the viewpoint of even more easily inhibiting molding shrinkage, the resin composition may include the plasticizer in an amount of 55 parts by weight or less, or 50 parts by weight or less, relative to 100 parts by weight of the chlorinated polyvinyl chloride resin composition.

From the viewpoint of easily improving the expansion ratio during foam molding, the acrylic polymer may include a structural unit derived from methyl methacrylate in an amount of 40 to 80% by weight, one or more of structural units derived from (meth)acrylic acid esters other than methyl methacrylate in an amount of 20 to 60% by weight, and one or more of structural units derived from other copolymerizable vinyl monomers in an amount of 0 to 5% by weight, or a structural unit derived from methyl methacrylate in an amount of 50 to 70% by weight, one or more of structural units derived from (meth)acrylic acid esters other than methyl methacrylate in an amount of 30 to 50% by weight, and one or more of structural units derived from other copolymerizable vinyl monomers in an amount of 0 to 5% by weight. In the present disclosure, (meth)acrylic acid is a generic term for methacrylic acid and acrylic acid.

Examples of the other (meth) acrylic acid esters include methacrylic acid alkyl esters having an alkyl group with 2 to 20 carbon atoms, and acrylic acid alkyl esters having an alkyl group with 1 to 20 carbon atoms. In the methacrylic acid alkyl esters, the alkyl group may have 2 to 14 carbon atoms, 2 to 12 carbon atoms, 2 to 10 carbon atoms, or 2 to 8 carbon atoms. In the acrylic acid alkyl esters, the alkyl group may have 1 to 14 carbon atoms, 1 to 12 carbon atoms, 1 to 10 carbon atoms, or 1 to 8 carbon atoms.

Specific examples of the other (meth)acrylic acid esters include: methacrylic acid alkyl esters having an alkyl group with 2 to 8 carbon atoms, such as ethyl methacrylate, propyl methacrylate, butyl methacrylate, and 2-ethylhexyl methacrylate; and acrylic acid alkyl esters having an alkyl group with 1 to 8 carbon atoms, such as methyl acrylate, ethyl acrylate, propyl acrylate, butyl acrylate, and 2-ethylhexyl acrylate.

One of the other (meth)acrylic acid esters may be used alone, or two or more of them may be used in combination.

The other copolymerizable vinyl monomers are not particularly limited as long as they are vinyl-based monomers copolymerizable with methyl methacrylate or the other (meth)acrylic acid esters, and the examples include: aromatic vinyl-based compounds such as styrene, α-methylstyrene, and p-methylenestyrene; vinyl cyanide-based compounds such as acrylonitrile and methacrylonitrile; and vinyl ester compounds such as vinyl acetate and vinyl propionate. One of the other copolymerizable vinyl monomers may be used alone, or two or more of them may be used in combination.

As the acrylic polymer, for example, commercially available products such as “Kane Ace (registered trademark) PA-40” and “Kane Ace (registered trademark) PA-60” manufactured by Kaneka Co., Ltd. can be used.

The resin composition includes the processing aid for foam molding in an amount of 3 to 30 parts by weight relative to 100 parts by weight of the chlorinated polyvinyl chloride resin composition. Thus, the expansion ratio of the resin composition during foam molding is increased, and the molding shrinkage is easily inhibited. From the viewpoint of further softening, the resin composition may include the processing aid for foam molding in an amount of 6 parts by weight or more, 10 parts by weight or more, or 12 parts by weight or more, relative to 100 parts by weight of the chlorinated polyvinyl chloride resin composition. From the viewpoint of more easily inhibiting molding shrinkage, the resin composition may include the processing aid for foam molding in an amount of 20 parts by weight or less, or 15 parts by weight or less, relative to 100 parts by weight of the chlorinated polyvinyl chloride resin composition.

The molding shrinkage inhibitor is a flaky inorganic powder having a mean particle size (D50) of 4 to 10 μm. Since the mean particle size (D50) of the flaky inorganic powder is 4 to 10 μm, the molding shrinkage of the resin composition can be inhibited. The mean particle size (D50) of the flaky inorganic powder may be 4.5 to 9 μm, or 5 to 8 μm. In the present disclosure, the mean particle size (D50) of the flaky inorganic powder is a volume-based mean particle size (D50), and can be measured by a laser diffraction method.

The average aspect ratio of the flaky inorganic powder is not particularly limited, but may be, 25 or more, 30 or more, or 35 or more, from the viewpoint of more easily inhibiting molding shrinkage of the resin composition, for example. The upper limit of the average aspect ratio of the flaky inorganic powder is not particularly determined, but may be, for example, 50 or less, or 45 or less. In the present Specification, the average aspect ratio means D50/Ta of the mean particle size (D50)/the average thickness (Ta). In the present Specification, the average thickness (Ta) can be measured by an image analysis method.

The flaky inorganic powder is not particularly limited as long as it is any flaky inorganic powder having a mean particle size (D50) of 4 to 10 μm, and it may include, for example, talc, mica, kaolin, barium sulfate, boron nitride, or flaky alumina. Among them, talc may be used from the viewpoint of further enhancing the molding shrinkage inhibition effect.

The resin composition includes the molding shrinkage inhibitor in an amount of 10 to 40 parts by weight relative to 100 parts by weight of the chlorinated polyvinyl chloride resin composition. Thus, the molding shrinkage of the resin composition is effectively inhibited, the resin composition is easily softened, and the expansion ratio during foam molding is easily improved. From the viewpoint of further enhancing the molding shrinkage inhibition effect, the resin composition may include the molding shrinkage inhibitor in an amount of 12 parts by weight or more, 15 parts by weight or more, or 18 parts by weight or more, relative to 100 parts by weight of the chlorinated polyvinyl chloride resin composition. From the viewpoint of easily softening and further improving the expansion ratio during foam molding, the resin composition may include the molding shrinkage inhibitor in an amount of 38 parts by weight or less, 35 parts by weight or less, or 30 parts by weight or less, relative to 100 parts by weight of the chlorinated polyvinyl chloride resin composition.

The resin composition may further include a foaming agent. Thus, a foam molded article having a high expansion ratio can be obtained. The foaming agent is not particularly limited, and for example, a chemical foaming agent such as an organic foaming agent or an inorganic foaming agent can be used. Examples of the organic foaming agent include azo-based, hydrazide-based, and nitroso-based foaming agents. Examples of the azo-based foaming agent include azodicarbonamide (ADCA), azobisisobutyronitrile (AIBN), barium azodicarboxylate, and diazoaminobenzene. Examples of the hydrazide-based foaming agent include p,p′-oxybis(benzenesulfonyl hydrazide) (OBSH), paratoluenesulfonyl hydrazide (TSH), and hydrazodicarbonamide (HDCA). An example of the nitroso-based foaming agent is dinitrosopentamethylenetetramine (DPT). Examples of the inorganic foaming agent include carbonate and nitrite. Examples of the carbonate include sodium carbonate, sodium bicarbonate, and ammonium carbonate. An example of the nitrite is ammonium nitrite. One kind of the foaming agents may be used alone, or two or more kinds thereof may be used in combination.

The blending amount of the foaming agent is not particularly limited, but for example, from the viewpoint of foamability and cell uniformity, the blending amount of the foaming agent may be 5 to 30 parts by weight, 8 to 25 parts by weight, or 10 to 20 parts by weight, relative to 100 parts by weight of the chlorinated polyvinyl chloride resin composition.

The resin composition may further include a stabilizer. The stabilizer is not particularly limited, and the examples thereof include an epoxy-based stabilizer, a barium-based stabilizer, a calcium-based stabilizer, a tin-based stabilizer, a zinc-based stabilizer, a hindered amine-based light stabilizer, a calcium-zinc-based stabilizer (Ca—Zn stabilizer), and a barium-zinc-based stabilizer (Ba—Zn stabilizer). One kind of the stabilizer may be used alone or two or more thereof may be used in combination. The blending amount of the stabilizer may be 8 parts by weight or less, 5 parts by weight or less, or 0.01 to 3 parts by weight, relative to 100 parts by weight of the chlorinated polyvinyl chloride resin composition.

The resin composition may further include a lubricant. The lubricant is not particularly limited, and the examples include higher fatty acid metal salts such as calcium stearate, higher alcohols, polyethylene waxes, ester waxes, and acrylic lubricants. One kind of the lubricants may be used alone, or two or more thereof may be used in combination. The blending amount of the lubricant may be 7 parts by weight or less, 5 parts by weight or less, 3 parts by weight or less, or 0.01 to 3 parts by weight, relative to 100 parts by weight of the chlorinated polyvinyl chloride resin composition.

The resin composition may further include a filler. The filler is not particularly limited, but the examples include inorganic powders other than inorganic flaky powders, namely, calcium carbonate, magnesium carbonate, calcium sulfate, magnesium sulfate and the like. One kind of the fillers may be used alone, or two or more thereof may be used in combination. The blending amount of the filler may be 50 parts by weight or less, 30 parts by weight or less, or 0.01 to 30 parts by weight, relative to 100 parts by weight of the chlorinated polyvinyl chloride resin composition.

The resin composition may include other additives such as a crosslinking agent, an antioxidant, a reinforcing agent, an ultraviolet absorber, an antistatic agent, a coloring agent, a surface treatment agent, a thixotropic agent, an antifungal agent, a flame retardant, a detergent or any other agent, as necessary, within a range not compromising one or more embodiments of the present invention. One of these additives may be used alone, or of two or more thereof may be used in combination. The blending amount of these additives may be 0 to 10 parts by weight, 0 to 8 parts by weight, 0 to 5 parts by weight, or 0 to 3 parts by weight, relative to 100 parts by weight of the chlorinated polyvinyl chloride resin composition.

More specifically, from the viewpoint of flame retardancy, the resin composition may include the chlorinated polyvinyl chloride resin composition in an amount of 40% by weight or more, 40 to 80% by weight, 50 to 75% by weight, or 55 to 70% by weight. From the viewpoint of enhancing flame retardancy, it is preferable that the resin composition includes only a chlorinated polyvinyl chloride resin composition as the halogen-containing resin and does not include a polyvinyl chloride resin composition.

From the viewpoint of softening, a hardness of the resin composition measured with a type A durometer in accordance with JIS K 6253-3 may be 92 or less, 90 or less, 85 or less, or 80 or less, where a test piece to be measured is a sheet-shaped unfoamed molded article of the resin composition having a thickness of 6 mm. The lower limit of the hardness is not particularly limited, but may be 35 or more, for example, from the viewpoint of a continuous service temperature. In the present Specification, the hardness can be measured specifically as described in Examples.

The resin composition can be prepared by stirring and mixing (compounding) the chlorinated polyvinyl chloride resin composition, the plasticizer, the processing aid for foam molding, and the molding shrinkage inhibitor. Further, the foaming agent, the stabilizer, the lubricant, the filler, and other additives may be added at the time of mixing. For the stirring and mixing, an agitator such as a ribbon blender, a Henschel mixer, a planetary mixer, or a Super mixer can be used.

The mixing step may be carried out while heating, and may be carried out while heating under the condition that the starting temperature is in the range of room temperature to 80 °C and the end temperature is in the range of 100 to 120 °C. Thereby, the plasticizer is easily absorbed by the chlorinated polyvinyl chloride resin composition, and the resin composition having an improved powder flowability is easily obtained. In the present Specification, the room temperature means a temperature in the range of 5 to 45 °C. In the case where the resin composition includes a pyrolytic foaming agent, the stirring and mixing need to be carried out under the condition that the foaming agent does not foam. For example, in the case where the pyrolysis temperature of the foaming agent is Td, the end temperature (highest temperature) at the time of heating may be [Td−50 °C] or lower, or [Td−60 °C] or lower.

### Foam Molded Article

A foam molded article according to one or more of embodiments of the present invention are obtained by foam molding the above-mentioned resin composition including the foaming agent. The foam molded article can be suitably used for films, sheets, electric wires, cords, packaging materials, vehicle parts, building materials and the like. By using the above-mentioned resin composition, the foam molded article is softened, the molding shrinkage is inhibited, and the expansion ratio is increased. The expansion ratio of the foam molded article may be 3 times or more, 3.5 times or more, or 4 times or more.

The foam molded article can be obtained by appropriately foam molding the resin composition including the foaming agent. The foam molding method is not particularly limited, and various foam molding methods can be appropriately employed in accordance with the application and the shape of the molded article. For example, the foam molded article may be produced by foam molding the resin composition including the foaming agent by a method of foaming simultaneously with molding, such as extrusion foam molding and injection foam molding. Alternatively, the foam molded article may be produced by molding the resin composition including the foaming agent by any of various molding methods such as roll molding, press molding, powder slash molding, extrusion molding, injection molding and calender molding in accordance with the application and shape of the molded article to produce an unfoam molded article, and then heating and foaming the unfoam molded article.

### EXAMPLES

Hereinafter, one or more embodiments of the present invention will be described more specifically with reference to Examples. One or more of embodiments of the present invention are not limited to the following Examples.

Compounds used in Examples and Comparative Examples will be described below.
Chlorinated polyvinyl chloride resin composition 1: Chlorinated polyvinyl chloride resin composition prepared by chlorinating a vinyl chloride homopolymer; chlorine content: 64% by weight; average degree of polymerization: 800; mean particle size: 150 μm; manufactured by Kaneka Co., Ltd.; grade name: “H438”
Chlorinated polyvinyl chloride resin composition 2: Chlorinated polyvinyl chloride resin composition obtained by chlorinating a vinyl chloride homopolymer; chlorine content: 67.1% by weight; average degree of polymerization: 700; mean particle size: 140 μm; manufactured by Kaneka Co., Ltd.; grade name: “H727”
Plasticizer 1: Butyl carbitol formal; molecular weight: 336; manufactured by Emery Oleochemicals GmbH; grade name: “EDENOL (registered trademark) 123”
Plasticizer 2: Bisbutyl carbitol adipate; molecular weight: 463; manufactured by Emery Oleochemicals GmbH; grade name: “EDENOL (registered trademark) 111”
Plasticizer 3: Dioctyl adipate; molecular weight: 371; manufactured by DIC Corporation
Processing aid 1 for foam molding: Acrylic polymer; manufactured by Kaneka Co., Ltd.; grade name: “PA-40”
Flaky inorganic powder 1: Talc; mean particle size (D50): 2.1 μm; manufactured by Nippon Talc Co., Ltd.; product name: “SG-95”
Flaky inorganic powder 2: Talc; mean particle size (D50): 5.0 μm; manufactured by Nippon Talc Co., Ltd.; product name: “PAOG-3”
Flaky inorganic powder 3: Talc; mean particle size (D50): 5.7 μm; manufactured by Nippon Talc Co., Ltd.; product name: “K-3”
Flaky inorganic powder 4: Talc; mean particle size (D50): 7 μm; manufactured by Nippon Talc Co., Ltd.; product name: “PAOG-2”
Flaky inorganic powder 5: Talc; mean particle size (D50): 8 μm; manufactured by Nippon Talc Co., Ltd.; product name: “K-1”
Flaky inorganic powder 6: Talc; mean particle size (D50): 15 μm; manufactured by Nippon Talc Co., Ltd.; product name: “MS-K”
Flaky inorganic powder 7: Talc; mean particle size (D50): 21 μm; manufactured by Nippon Talc Co., Ltd.; product name: “MS-KY”

The physical properties of the compounds used in Examples and Comparative Examples were measured as follows.

### Chlorine Content in Chlorinated Polyvinyl Chloride Resin Composition

Measurement was carried out in accordance with JIS K 7229.

### Average Degree of Polymerization of Chlorinated Polyvinyl Chloride Resin Composition

The average degree of polymerization of polyvinyl chloride resin composition as a raw material was adopted as the average degree of polymerization of the chlorinated polyvinyl chloride resin composition. The average degree of polymerization of polyvinyl chloride resin composition was measured in accordance with a method described in JIS K 6720-2 Appendix/Test Method for Polyvinyl chloride resin composition.

### Mean Particle Size of Chlorinated Polyvinyl Chloride Resin Composition

The mean particle size of chlorinated polyvinyl chloride resin composition was measured in accordance with JIS K 7369.

### Mean Particle Size of Inorganic Powder

The mean particle size of inorganic powder, that is, a volume-based mean particle size (D50), was measured by laser diffraction.

### Example 1 to 7, Comparative Example 1 to 4

To 100 parts by weight of a chlorinated polyvinyl chloride resin composition 1, were added 12 parts by weight of a processing aid 1 for foam molding, 3 parts by weight of a calcium-zinc-based stabilizer, 1.3 parts by weight of a lubricant (i.e., 1 part by weight of an acrylic lubricant, and 0.3 parts by weight of an ester wax), 5 parts by weight of calcium carbonate (filler), and also a plasticizer and a flaky inorganic powder shown in Table 1 below in the amounts shown in Table 1 below, and the components were heated to 110 °C while being mixed in a Super mixer (manufactured by Kawata Mfg. Co., Ltd.). The mixture was then cooled to room temperature (20±5 °C) to obtain a chlorinated polyvinyl chloride resin composition (compound).

### Example 8 to 15, Comparative Example 5 to 7

To 100 parts by weight of a chlorinated polyvinyl chloride resin composition 1, were added 12 parts by weight of a processing aid 1 for foam molding, 3 parts by weight of a calcium-zinc-based stabilizer, 1.3 parts by weight of a lubricant (i.e., 1 part by weight of an acrylic lubricant, and 0.3 parts by weight of an ester wax), 5 parts by weight of calcium carbonate (filler), and also a plasticizer and a flaky inorganic powder shown in Table 1 below in the amounts shown in Table 2 below, and the components were heated to 110 °C while being mixed in a Super mixer (manufactured by Kawata Mfg. Co., Ltd.). The mixture was then cooled to room temperature (20±5 °C) to obtain a chlorinated polyvinyl chloride resin composition (compound).

The molding shrinkage inhibition and the hardness of the chlorinated polyvinyl chloride resin compositions obtained in Examples and Comparative Example were measured and evaluated as follows. The results are shown in Tables 1 and 2 below.

### Molding Shrinkage Inhibition

100 g of a chlorinated polyvinyl chloride resin composition (compound) was kneaded on a mixing roll (a twin-roll mill manufactured by Nishimura Koki Co., Ltd.; roll gap: 0.6 mm; roll circumference (roll diameter): 48 cm; and roll length: 31 cm) at a set temperature (surface temperature) of 155 °C for 5 minutes to obtain a sheet having a thickness of approximately 0.8 mm. Thereafter, the mixture was allowed to stand for 120 minutes, cooled to room temperature (20±5 °C), and then, the length of the sheet was measured. In the case where no molding shrinkage occurs, the length of the sheet is 48 cm, which is the same as the roll diameter.

As for Examples 1 to 7 and Comparative Examples 1 to 4, the length of the sheet obtained in Comparative Example 1 including no inorganic powder was set to 1, and a relative value was calculated to obtain a molding shrinkage inhibition relative value.

As for Examples 8 to 15 and Comparative Examples 6, the length of the sheet obtained in Comparative Example 6 including no inorganic powder was set to 1, and a relative value was calculated to obtain a molding shrinkage inhibition relative value. As for Comparative Examples 5 and 7, the length of the sheet obtained in Comparative Example 5 including no inorganic powder was set to 1, and a relative value was calculated to obtain a molding shrinkage inhibition relative value. When the molding shrinkage inhibition relative value is larger, the molding shrinkage inhibition performance is considered to be enhanced.

### Hardness

The hardness was measured using an Askar hardness tester Type A (Type A durometer) conforming to JIS K 6253-3. The test piece was a sheet having a thickness of 6 mm, which was obtained by laminating roll sheets and pressing them in a press machine (manufactured by Shoji Tekko K.K.) at 160 °C and 3 MPa for 3 minutes. For the roll sheet, a roll sheet obtained in the above evaluation of molding shrinkage inhibition was used.

TABLE 1

| | | | Flaky | | | |
|---|---|---|---|---|---|---|
| | Plasticizer | | inorganic powder | | Molding | |
| | | Blending | | Blending | shrinkage | Shore |
| | | amount | | amount | inhibition | hard- |
| | | (parts by | | (parts by | relative | ness |
| | Kind | mass) | Kind | mass) | value | A |
| Example 1 | 1 | 40 | 2 | 20 | 1.10 | |
| Example 2 | 1 | 40 | 3 | 20 | 1.11 | |
| Example 3 | 1 | 40 | 4 | 20 | 1.11 | 74 |
| Example 4 | 1 | 40 | 5 | 20 | 1.10 | 71 |
| Example 5 | 1 | 40 | 4 | 40 | 1.15 | 79 |
| Example 6 | 1 | 40 | 2 | 10 | 1.10 | 68 |
| Example 7 | 1 | 40 | 2 | 40 | 1.18 | 80 |
| Comparative | 1 | 40 | None | 0 | 1 | 65 |
| Example 1 | | | | | | |
| Comparative | 1 | 40 | | 20 | 1.04 | |
| Example 2 | | | | | | |
| Comparative | 1 | 40 | 6 | 20 | 1.07 | 72 |
| Example 3 | | | | | | |
| Comparative | 1 | 40 | 7 | 20 | 1.07 | 71 |
| Example 4 | | | | | | |

TABLE 2

| | Plasticizer | | Inorganic powder | | Molding | |
|---|---|---|---|---|---|---|
| | | Blending | | Blending | shrinkage | Shore |
| | | amount | | amount | inhibition | hard- |
| | | (parts by | | (parts by | relative | ness |
| | Kind | mass) | Kind | mass) | value | A |
| Example 8 | 1 | 30 | 2 | 20 | 1.12 | 89 |
| Example 9 | 2 | 30 | 2 | 20 | 1.10 | 89 |
| Example 10 | 3 | 30 | 2 | 20 | 1.14 | 91 |
| Example 11 | 1 | 40 | 2 | 20 | 1.10 | 76 |
| Example 12 | 2 | 40 | 2 | 20 | 1.12 | 71 |
| Example 13 | 3 | 40 | 2 | 20 | 1.14 | 79 |
| Example 14 | 3 | 50 | 2 | 20 | 1.11 | 68 |
| Example 15 | 3 | 60 | 2 | 20 | 1.11 | 56 |
| Comparative | 2 | 20 | None | 0 | 1 | 97 |
| Example 5 | | | | | | |
| Comparative | 2 | 30 | None | 0 | 1 | 94 |
| Example 6 | | | | | | |
| Comparative | 2 | 20 | 2 | 20 | 1.09 | 88 |
| Example 7 | | | | | | |

### Examples 16

### Compounding Step

To 100 parts by weight of a chlorinated polyvinyl chloride resin composition 1, were added 12 parts by weight of a processing aid 1 for foam molding, 4 parts by weight of a calcium-zinc-based stabilizer, 2 parts by weight of a lubricant (i.e., 1 part by weight of an acrylic lubricant, 0.5 parts by weight of an ester wax, and 0.5 parts by weight of a paraffin wax), 5 parts by weight of calcium carbonate (filler), 40 parts by weight of a plasticizer 3, 20 parts by weight of a flaky inorganic powder 2, and 5 parts by weight of a foaming agent (main ingredient: sodium hydrogen carbonate; thermal decomposition temperature: 150 °C (catalog value); manufactured by Eiwa Chemical Ind. Co., Ltd.), and the components were heated to 110 °C while being mixed in a 20 L Super mixer (manufactured by Kawata Mfg. Co., Ltd.). The mixture was then cooled to 40 °C or lower to obtain a chlorinated polyvinyl chloride resin composition (compound).

### Foam Molding Step

Using an extruder (manufactured by Tanabe Plastics Machinery Co., Ltd.; product name: “VS-50”), the chlorinated polyvinyl chloride resin composition (compound) was extruded into a round rod with a die lip diameter of 12 mm at a temperature in the range of 145 to 165 °C and a screw rotation speed of 10 rpm, whereby an extruded foam molded article was obtained. Immediately after the extrusion, the maximum diameter of the extruded foam molded article was measured, two points were marked so that the length was 107 mm, and the volume (V1) of the columnar extruded foam molded article immediately after molding and not cooled was calculated. Thereafter, the extruded foam molded article was allowed to stand at room temperature (20±5 °C) for 24 hours or more. The diameter of the extruded foam molded article after standing at room temperature and the distance between the two marked points were measured, and the volume (V2) of the columnar extruded foam molded article after cooling was calculated.

### Examples 17 to 20

A chlorinated polyvinyl chloride resin composition (compound) was prepared in the same manner as in Example 16 except that the blending amount of the processing aid 1 for foam molding or the flaky inorganic powder 2 was modified as shown in Table 3 below, foam molding was carried out in the same manner as in Example 16, and the volume (V1) of the columnar extruded foam molded article immediately after molding and not cooled and the volume (V2) of the columnar extruded foam molded article after cooling were calculated.

### Example 21

A chlorinated polyvinyl chloride resin composition (compound) was prepared in the same manner as in Example 16 except that the chlorinated polyvinyl chloride resin composition 2 was used instead of the chlorinated polyvinyl chloride resin composition 1 and the plasticizer 1 was used instead of the plasticizer 3, foam molding was carried out in the same manner as in Example 16, and the volume (V1) of the columnar extruded foam molded article immediately after molding and not cooled and the volume (V2) of the columnar extruded foam molded article after cooling were calculated.

### Comparative Example 8

A chlorinated polyvinyl chloride resin composition (compound) was prepared in the same manner as in Example 16 except that the flaky inorganic powder 2 was not blended, foam molding was carried out in the same manner as in Example 16, and the volume (V1) of the columnar extruded foam molded article immediately after molding and not cooled and the volume (V2) of the columnar extruded foam molded article after cooling were calculated.

### Comparative Example 9

A chlorinated polyvinyl chloride resin composition (compound) was prepared in the same manner as in Example 16 except that neither the processing aid 1 for foam molding nor the flaky inorganic powder 2 was blended, foam molding was carried out in the same manner as in Example 16, and the volume (V1) of the columnar extruded foam molded article immediately after molding and not cooled and the volume (V2) of the columnar extruded foam molded article after cooling were calculated.

For Examples 16 to 21 and Comparative Examples 8 and 9, the molding shrinkage rates and the expansion ratios were calculated as follows. The results are shown in Table 3 below. A molding shrinkage rate of 40% or less and an expansion ratio of 2 or more were considered acceptable. Table 3 below also shows the blending amounts of the processing aid 1 for foam molding and the flaky inorganic powder 2 relative to 100 parts by weight of the chlorinated polyvinyl chloride resin composition 1 or the chlorinated polyvinyl chloride resin composition 2.

### Molding Shrinkage Rate

Molding shrinkage rate (%)=100×[(V1−V2)/V1]

### Expansion Ratio

After weighing the weight (W0) of the columnar extruded foam molded article after cooling, the expansion ratio was calculated by the following equation.

Expansion ratio (times)=Density of material (g/mL)/density of foam molded article (g/mL)=ρ/(WO/V2)

TABLE 3

| | Blending amount | | | |
|---|---|---|---|---|
| | (parts by mass) | | | Expansion |
| | Processing aid for | Flaky inorganic | Shrinkage | ratio |
| | foam molding | powder | rate (%) | (times) |
| Example 16 | 12 | 20 | 33.9 | 4.3 |
| Example 17 | 12 | 15 | 37.4 | 3.5 |
| Example 18 | 12 | 40 | 26.3 | 4.0 |
| Example 19 | 5 | 20 | 29.8 | 2.9 |
| Example 20 | 20 | 20 | 39.5 | 3.8 |
| Example 21 | 12 | 20 | 39.7 | 3.2 |
| Comparative | 12 | 0 | 48.0 | 3.5 |
| Example 8 | | | | |
| Comparative | 0 | 0 | 23.0 | 1.5 |
| Example 9 | | | | |

The results in Tables 1 to 3 show the following:
(1) Since the chlorinated polyvinyl chloride composition includes 30 parts by weight or more of a plasticizer, a softened chlorinated polyvinyl chloride composition can be obtained, and for example, the shore hardness A measured using a 6 mm thick sheet-like unfoamed molded article as a test piece is 92 or less.
(2) Since the chlorinated polyvinyl chloride composition includes an acrylic polymer, the acrylic polymer functions as a processing aid for foam molding, and a high expansion ratio can be obtained when the chlorinated polyvinyl chloride composition is foam-molded.
(3) In the meantime, when the chlorinated polyvinyl chloride composition includes a plasticizer and a processing aid for foam molding, the molding shrinkage (i.e. shrinkage during cooling after molding) increases, but the molding shrinkage (i.e. shrinkage during cooling after molding) of the chlorinated polyvinyl chloride composition can be inhibited by using a flaky inorganic powder (more specifically, talc) having a mean particle size of 4 to 10 μm.

As described above, according to one or more of embodiments of the present invention, it is possible to provide a chlorinated polyvinyl chloride composition for foam molding, the composition is softened, inhibits molding shrinkage, and exhibits a high expansion ratio during foam molding by use in combination of predetermined amounts of a plasticizer, an acrylic polymer, and flaky inorganic powder having a mean particle size of 4 to 10 μm.

One or more embodiments of the present invention are not particularly limited, but may include, for example, the following embodiments.

[1]A chlorinated polyvinyl chloride resin composition for foaming, including:
a chlorinated polyvinyl chloride resin composition in an amount of 100 parts by weight;
a plasticizer in an amount of 30 to 60 parts by weight;
a processing aid for foam molding in an amount of 3 to 30 parts by weight; and
a molding shrinkage inhibitor in an amount of 10 to 40 parts by weight, wherein the processing aid for foam molding is an acrylic polymer, and
the molding shrinkage inhibitor is a flaky inorganic powder having a mean particle size (D50) of 4 to 10 μm.

[2] The chlorinated polyvinyl chloride resin composition for foaming according to [1], wherein the acrylic polymer includes a structural unit derived from methyl methacrylate in an amount of 40 to 80% by weight, one or more of structural units derived from (meth)acrylic acid esters other than methyl methacrylate in an amount of 20 to 60% by weight, and one or more of structural units derived from other copolymerizable vinyl monomers in an amount of 0 to 5% by weight.

[3] The chlorinated polyvinyl chloride resin composition for foaming according to [1] or [2], wherein the plasticizer includes at least one ether plasticizer Z selected from the group consisting of a fatty acid ester-based ether plasticizer and a formal-based ether plasticizer.

[4] The chlorinated polyvinyl chloride resin composition for foaming according to [3], wherein the ether plasticizer Z includes at least one selected from the group consisting of bis[2-(2-butoxyethoxy)ethyl] adipate and bis(butyldiethylglycol) formal.

[5] The chlorinated polyvinyl chloride resin composition for foaming according to any one of [1] to [4], wherein the chlorinated polyvinyl chloride resin composition for foaming includes the chlorinated polyvinyl chloride resin composition in an amount of 40 to 80% by weight.

[6] The chlorinated polyvinyl chloride resin composition for foaming according to any one of [1] to [5], wherein a hardness measured with a type A durometer in accordance with JIS K 6253-3 is 92 or less, where a test piece to be measured is a sheet-shaped unfoamed molded article having a thickness of 6 mm and including the chlorinated polyvinyl chloride resin composition for foaming.

[7] The chlorinated polyvinyl chloride resin composition for foaming according to any one of [1] to [6], wherein the chlorinated polyvinyl chloride resin composition for foaming further includes a foaming agent.

[8]A foam molded article formed by foam molding the chlorinated polyvinyl chloride resin composition for foaming according to [7].

[9] The foam molded article according to [8], wherein the foam molded article has an expansion ratio of 3 times or more.

One or more embodiments described above are to be regarded in all respects as mere examples of the present invention and are not intended to be limiting. Those skilled in the art to which the present invention pertains will be able, in light of the above teachings, to construct various embodiments incorporating the principles of the present invention without departing from the spirit and essential features of the present invention, even if not explicitly described herein.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A foamable chlorinated polyvinyl chloride resin composition, comprising:
a chlorinated polyvinyl chloride resin composition in an amount of 100 parts by weight;
a plasticizer in an amount of 30 to 60 parts by weight;
a processing aid for foam molding in an amount of 3 to 30 parts by weight; and
a molding shrinkage inhibitor in an amount of 10 to 40 parts by weight, wherein
the processing aid for foam molding is an acrylic polymer, and
the molding shrinkage inhibitor is a flaky inorganic powder having a mean particle size (D50) of 4 to 10 μm.

2. The foamable chlorinated polyvinyl chloride resin composition according to claim 1, wherein the acrylic polymer comprises:
a structural unit derived from methyl methacrylate in an amount of 40 to 80% by weight;
one or more of structural units derived from (meth)acrylic acid esters other than the methyl methacrylate in an amount of 20 to 60% by weight; and
one or more of structural units derived from other copolymerizable vinyl monomers in an amount of 0 to 5% by weight.

3. The foamable chlorinated polyvinyl chloride resin composition according to claim 1, wherein the plasticizer comprises at least one ether plasticizer Z selected from the group consisting of a fatty acid ester-based ether plasticizer and a formal-based ether plasticizer.

4. The foamable chlorinated polyvinyl chloride resin composition according to claim 3, wherein the at least one ether plasticizer Z comprises at least one selected from the group consisting of bis[2-(2-butoxyethoxy)ethyl] adipate and bis(butyldiethylglycol) formal.

5. The foamable chlorinated polyvinyl chloride resin composition according to claim 1, comprising the chlorinated polyvinyl chloride resin composition in an amount of 40 to 80% by weight.

6. The foamable chlorinated polyvinyl chloride resin composition according to claim 1, wherein a hardness measured with a type A durometer in accordance with JIS K 6253-3 is 92 or less, wherein a test piece to be measured is a sheet-shaped unfoamed molded article having a thickness of 6 mm and comprising the foamable chlorinated polyvinyl chloride resin composition.

7. The foamable chlorinated polyvinyl chloride resin composition according to claim 1, further comprising a foaming agent.

8. A foam molded article formed by foam molding the foamable chlorinated polyvinyl chloride resin composition according to claim 7.

9. The foam molded article according to claim 8, wherein the acrylic polymer comprises:
a structural unit derived from methyl methacrylate in an amount of 40 to 80% by weight;
one or more of structural units derived from (meth)acrylic acid esters other than the methyl methacrylate in an amount of 20 to 60% by weight; and
one or more of structural units derived from other copolymerizable vinyl monomers in an amount of 0 to 5% by weight.

10. The foam molded article according to claim 9, wherein the plasticizer comprises at least one ether plasticizer Z selected from the group consisting of a fatty acid ester-based ether plasticizer and a formal-based ether plasticizer.

11. The foam molded article according to claim 10, wherein the at least one ether plasticizer Z comprises at least one selected from the group consisting of bis[2-(2-butoxyethoxy)ethyl] adipate and bis(butyldiethylglycol) formal.

12. The foam molded article according to claim 8, wherein the foamable chlorinated polyvinyl chloride resin composition comprises the chlorinated polyvinyl chloride resin composition in an amount of 40 to 80% by weight.

13. The foam molded article according to claim 8, having an expansion ratio of 3 times or more.
